(19) United States
(12) Patent Application Publication
(10) Pub. No.: US 2014/0052638 A1
(43) Pub. Date: Feb. 20, 2014

(54) METHOD AND SYSTEM FOR PROVIDING A CARD PAYMENT SERVICE USING A MOBILE PHONE NUMBER

(71) Applicants: Hyun Cheol Chung, Yongin-si (KR); Seong Il Cheong, Gwanak-gu (KR); Shin Beom Kang, Seocho-gu (KR); Jong Hoon Park, Seongnam-si (KR)

(72) Inventors: Hyun Cheol Chung, Yongin-si (KR); Seong Il Cheong, Gwanak-gu (KR); Shin Beom Kang, Seocho-gu (KR); Jong Hoon Park, Seongnam-si (KR)

(73) Assignee: Hyun Cheol CHUNG, Yongin-si (KR)

(21) Appl. No.: 14/005,679

(22) PCT Filed: Mar. 19, 2012
(86) PCT No.: PCT/KR2012/001926

§ 371 Date: Oct. 25, 2013

(30) Foreign Application Priority Data
Mar. 21, 2011 (KR) 10-2011-0025029
Mar. 15, 2012 (KR) 10-2012-0026532

(51) Int. Cl. G06Q 20/32

(52) U.S. Cl. CPC G06Q 20/322
USPC 705/44

(57) ABSTRACT

A method and system for providing a card payment using a mobile phone number. A service server receives a payment request from an affiliate system through a wired/wireless data network, the payment request being inputted through a user terminal and including a mobile phone number of a mobile terminal of a user. A telephone call is connected to the mobile terminal using the mobile phone number included in the received payment request. When the telephone call is connected, an input of a service password is requesting through the connected telephone call. When a service password received through the telephone call from the mobile terminal is identical to a service password stored in the service server, a payment authentication process is performed using a virtual card number generated by the service server, the virtual card number being mapped to a card matching the mobile phone number.

### TECHNICAL FIELD

The present invention relates to a method and system for providing a card payment using a mobile phone number, and more particularly, to a system and method which allows a user to simply perform card payment using the number of his/her mobile phone (e.g. a mobile phone number), and at the same time, perform card payments without installing a separate application or a piece of software in his/her mobile terminal.

The present invention also relates to a system and method that can efficiently manage a change in the mobile phone number that may occur when card payment is performed using the mobile phone number.

The present invention also relates to a system and method that can overcome problems that may occur when a payment process is being performed by establishing a phone call.

The present invention also relates to a method and system that can enhance security by allowing one payment process to be performed via different channels (i.e. tow-tier verification) by differentiating a payment request channel from a password input channel.

The present invention also relates to a method and system that can enhance security by preventing card information (e.g. card number or expiration date) that is used for card payments from being circulated for payments on the network.

### BACKGROUND ART

In response to the development of wired and wireless networks, payments for products and services are also being made by a variety of online payment methods on such wired and wireless networks.

Among the variety of online payment methods, a mobile payment method and a card payment method are most typically used.

According to the mobile payment method of the related art, when a user requests payment on the Internet using a mobile phone number (e.g. a portable telephone number) at an affiliate site which is for a mobile payment service, verification information is received at a mobile terminal that matches the mobile phone number, and the received verification information is inputted at the affiliate site, so that payment is accomplished.

In addition, according to the card payment method of the related art, when information (e.g. the serial number of a credit card or expiration date) of a card (e.g. a credit card or a check card) and payment information (e.g. a password) are inputted at an affiliate site, payment is performed by confirming whether or not the information of a card matches the payment information.

The mobile payment method of the related art has an advantage of being very convenient since the payment is possible when the mobile terminal (e.g. a portable phone) is possessed. However, since the payment is possible only with the possession of the mobile terminal, safety is significantly vulnerable, which is problematic. Therefore, this method is mainly used in micro-payment where small amounts of money are paid.

In addition, the card payment method of the related art is the method which performs the payment by requiring the user directly input the card information or using the card information that is previously stored in a computer or the like. In general, the card must pay limitlessly within the credit limit or the amount of money in a specific account. Therefore, it is preferred that this method provide higher levels of safety or security than the mobile payment method.

However, a security protocol having a high level of safety is not substantially provided for the card payment. Even though a security protocol having a high level of safety is provided, the related-art card payment method is basically assumed that the card information and the payment confirmation password of the card shall be circulated on the network. Furthermore, the card information and the password are circulated through the same channel (e.g. Internet), even though they are circulated as being encoded. Therefore, the problem is that fatal damage may be caused when the card information and the password, which are powerful tools needed to pay a large amount of money, are leaked.

Therefore, there are required a payment method and system that can combine the convenience of a mobile payment method and the advantage of the card payment by allowing the card payment to be performed using the mobile phone number while basically preventing the card information and/or password from being circulated on the network.

In addition, when the user is required to install an application or a piece of software in the mobile terminal for the card payment, there are problems in that the convenience of use is significantly decreased and a piece of software that the user does not want must be installed. In addition, there are some related-art mobile terminals that do not support data communication, or separate software cannot be installed in some related-art mobile terminals. Therefore, a payment solution that can be commonly applied to such mobile terminals is required.

### DISCLOSURE

### Technical Problem

It is therefore an object of the present invention to provide a method and system for providing a card payment in which at least one piece of card information is matched to a mobile phone number (e.g. a portable telephone number) such that a user can use the mobile phone number for card information when actually performing a payment, thereby performing the card payment without inputting the card information.

In order to overcome the problem of security that may occur when the mobile phone number is used, also provided is a method and system for providing a card payment in which a channel through which a payment is performed (i.e. the Internet) and a channel through which a password is acquired are divided so that a payment process can be performed through different channels, thereby improving security. In addition, the payment process is performed using a virtual card number mapped to a card that is used at the payment, such that card information used at the payment can be managed only by the card company. This can consequently prevent the card information from being circulated on the network, thereby improving security.

In addition, when a card payment is performed using a mobile phone number, the mobile phone number acts like user identification (ID). There is a problem in that the mobile phone number can be changed for a variety of reasons. Therefore, also provided is a method and system which can effectively verify a new telephone number when the mobile phone number is changed.

Also provided is a method and system which can perform a card payment using a mobile phone number even when a mobile terminal cannot access a data network (e.g. the Internet or a WAP server) or a payment software program cannot be installed.

In some cases, a telephone call cannot be connected due to the circumstance of the user when a payment confirmation (e.g. an input of a password) is performed through the telephone call. Therefore, also provided is a method and system which allows the user to perform a payment process.

### Advantageous Effects

In the method and system for providing a card payment using a mobile phone number according to the present invention, a card payment can be performed using a mobile phone number (or user identification information), or well-known information, without having to input card information. It is therefore possible to prevent card information from leaking which would otherwise cause severe damage. In addition, since the payment process is performed between the service server and the card company system using a virtual card number mapped to the card number, it is possible to ensure that the card information be never circulated on the network while passing through the payment process.

Furthermore, when there is a change in the mobile phone number of the user, it is possible to efficiently verify the change in the telephone number. There is an effect in that a payment service can be provided even if user-specific unique information (e.g. resident registration number) is not separately managed.

In addition, since payment request information (e.g. mobile phone number) and the related password are not circulated through one channel but are circulated through different channels (e.g. the Internet and a mobile communication network), there is an effect in that security can be improved through actual 2-tier verification.

Furthermore, since a password is verified through a telephone call, there is an effect in that a payment can be performed irrespective of the type of a mobile terminal, without installation of software (e.g. a virtual machine (VM)) in the mobile terminal.

In addition, when a password is verified through a telephone call, a user may not answer the call in some cases. Even in this case, the verification can be performed later through a telephone call.

### DESCRIPTION OF DRAWINGS

The brief description of the drawings is provided for better understanding of the drawings which are referred to in the detailed description of the present invention.

FIG. 1 is a view illustrating a conceptual configuration of a system for realizing a method for providing a card payment using a mobile phone number according to an embodiment of the present invention;

FIG. 2 is a view illustrating a schematic configuration of a system for providing a card payment using a mobile phone number according to an embodiment of the present invention;

FIG. 3a is a view illustrating a card registration process or an information changing process in the method for providing a card payment using a mobile phone number according to an embodiment of the present invention;

FIG. 3b is a view illustrating the card registration process in the method for providing a card payment using a mobile phone number according to an embodiment of the present invention;

FIG. 4 is a view schematically illustrating a data flow in the method for providing a card payment using a mobile phone number according to an embodiment of the present invention;

FIG. 5 is a view showing an example of a payment UI provided to a user in order to embody the method for providing a card payment using a mobile phone number according to an embodiment of the present invention; and

FIG. 6 is a view showing an example of information that can be maintained in the service server in order to embody the method for providing a card payment using a mobile phone number according to an embodiment of the present invention.

### MODE FOR INVENTION

The present invention, advantages associated with the operation of the present invention and objects that are realized by the practice of the present invention will be apparent from the accompanying drawings which illustrate exemplary embodiments of the present invention and the detailed description of the present invention which are illustrated in the drawings.

Throughout the specification, it will be understood that, when an element is referred to as “transmitting” data to another element, the element not only can directly transmit the data to another element but also indirectly transmit the data to another element via at least one intervening element.

In contrast, when an element is referred to as “directly transmitting” data to another element, the element can transmit the data to another element without an intervening element.

The present invention will now be described more fully hereinafter with reference to the accompanying drawings, in which exemplary embodiments thereof are shown. Reference should be made to the drawings, in which the same reference numerals are used throughout the different drawings to designate the same or similar components.

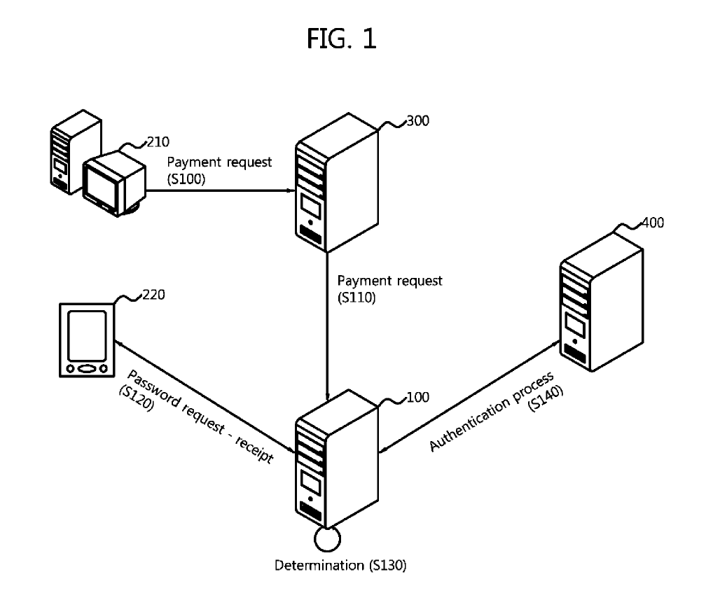

FIG. 1 is a view illustrating the conceptual configuration of a system for realizing a method for providing a card payment using a mobile phone number according to an embodiment of the present invention.

Referring to FIG. 1, a service server 100 can be provided in order to embody the method for providing a card payment using a mobile phone number according to an embodiment of the present invention. In addition, the service server 100 can transmit or receive data to or from an affiliate system 300 and/or a card company system 400. In some implementations, a value-added network (VAN) system (not shown) can also be provided between the service server 100 and the card company system 400.

The service server 100 can receive a payment request from the affiliate system 300. The affiliate system 300 can receive a payment request from a user terminal 210, and send the received payment request to the service server 100. Then, according to the technical idea of the present invention, the service server 100 can request a password to be inputted for a payment and receive the password through a telephone call through a mobile terminal 220 of a user. In addition, if necessary, the service server 100 can transmit or receive data required for an authorization process to or from the card company system 400.

For instance, at S100, a user who intends to perform a payment can send a payment request to the affiliate system 300 using the user terminal 210 (e.g. a computer). The terminal 210 can be understood as including any type of data processing unit (e.g. a computer, a mobile terminal, or a set-top box) which can request the payment via the affiliate system 300.

In addition, the affiliate system 300 can provide any type of data processing system which the terminal 210 can access and which will receive the payment request, for example, a website, webpage, interactive broadcast server and/or payment module. Here, the payment request S100 can be performed on the wired and/or wireless data network, i.e. a first communication channel (e.g. Internet or a mobile Internet). The user can input his/her mobile phone number (e.g. a portable telephone number or a USIM number) using the user terminal 210. The mobile phone number can be the telephone number of the mobile terminal 220 which is used by the user who requests a payment. In some implementations, the user can further input user identification information (e.g. name or birth date) using the mobile terminal 220. At this time, the user identification information (e.g. name or birth date) can be used as a certain type of confirmation information.

This is because, when a payment can be requested using only a mobile phone number, there is a danger in that a person having an unlawful intention may be able to acquire a service password by connecting an ARS call to the mobile phone number in the same fashion as in the password verification method according to the present invention which will be described later. In addition, since a mobile phone number can be well-known information, there may be a danger in that a payment is requested using the known mobile phone number and then passwords are repeatedly inputted.

Therefore, in the case of attempting to identify the payment requester based on the mobile phone number, which is published information, security can be enhanced additionally using specific confirmation information (e.g. name or birth date).

Therefore, the payment request can include the mobile phone number and the confirmation information. When the payment request is received, the service server 100 can determine whether or not the mobile phone number matches the confirmation information. Only after it is determined that the mobile phone number matches the confirmation information, a service password verification process can be performed as will be described later. For this, the service server 100 can have the mobile phone number and the matching confirmation information stored therein.

Consequently, according to the technical idea of the present invention, there is an effect in that this confirmation information is received together with the mobile phone number and can be used as information for first verification. Since the mobile phone number is a piece of information that may be published, a fatal problem can occur when the service password is leaked or disclosed. Therefore, when second verification using the service password is performed as a second authentication after the first verification using the confirmation information, there is an effect in that the safety level of the service can be significantly increased.

In addition, when the payment request has been received by a preset number or more for the same mobile phone number for a preset period while the confirmation information has been changed, the service server 100 can reject the payment request or enhance the level of safety by performing a separate additional verification process in addition to the service password verification process.

The confirmation information can be a piece of information of which the owner of the mobile phone number is aware, preferably, a piece of information which is barely known to others (e.g. birth date).

In this fashion, the user can pay using his/her card by inputting his/her mobile phone number and/or his/her identification information (confirmation information) without directly inputting his/her card information.

Then, at S110, the affiliate system 300 can transmit the received payment request to the service server 100. The payment request can include the information that the user inputted, i.e. the mobile phone number (and selectively the user identification information), and a certain request signal that is used for requesting the payment. Of course, the payment request that the service server 100 receives can further include other information, such as the price to be paid or affiliate identification information.

Then, according to the technical idea of the present invention, the service server 100 can execute a certain process that can perform the card payment using the received information. For this, at S120, the service server 100 can request a password from the mobile terminal 220 of the user, using the mobile phone number included in the received payment request.

In addition, at S120, the password can be received from the mobile terminal 220. In this case, at S120, the service server 100 can request the password via a communication channel different from the first communication channel, i.e. a telephone call.

The service server 100 can include an auto response system (ARS) in order to establish the telephone call with the mobile terminal 220. In some implementations, the service server 100 can control the ARS by being connected thereto in order to embody the technical idea of the present invention.

Accordingly, the service server 100 can provide a system structure that can maintain security even if information leaks from one channel by using different channels for the channel through which the payment is requested (i.e. a data network, such as wired Internet or wireless Internet) and the channel through which the password is confirmed (i.e. a telephone network). In addition, as an effect, when the password is received via the ARS, there is high possibility that the information will not be leaked by an attack on the data network, through a virus, worm or malware.

The service server 100 can set an auto response system (ARS, not shown) call to the mobile terminal 220 that matches the mobile phone number. When the ARS call, or a telephone call, is established, it is possible to request an input of the service password for the payment service according to an embodiment of the present invention.

For example, the service server 100 can extract the mobile phone number from the received payment request information, and output the extracted mobile phone number to an auto response system (ARS, not shown). Then, the ARS can connect a wireless call to the mobile terminal 220. That is, the ARS can call to the mobile terminal 220. Then, the ARS can request the payment password from the mobile terminal 220. In response to the request, the user can input the service password that is stored (registered) in the service server 100, previously set by the user. Then, the service server 100 can receive the password inputted from the ARS, and compare it with the password that is previously stored. Consequently, the service server 100 can determine that the verification for the service that embodies the method for providing a card payment using a mobile phone number according to an embodiment of the present invention (hereinafter, referred to as “service”) has succeeded (S130).

As such, the method for providing a card payment using a mobile phone number according to the technical idea of the present invention verifies the password through a telephone call. Therefore, there is an effect in that neither an integrated circuit (IC) chip nor software are required to be installed in the mobile terminal 220 for the purpose of a payment. Accordingly, the service according to an embodiment of the present invention can be used in 2G phones of the related art with no difficulty.

When it is determined that the verification according to an embodiment of the present invention has succeeded, the service server 100 can perform a credit card payment authorization process (S140). For this, the service server 100 can transmit an authentication request signal to the card company system 400 depending on card identification information, which is previously registered so as to correspond to the mobile phone number. In some implementations, the authentication request signal can be transmitted to the card company system 400 via a VAM system (not shown).

The authentication request signal can include payment information such as the amount of money to be paid. In addition, the authentication request signal can include a virtual card number that matches the mobile phone number. That is, the virtual card number matching the mobile phone number can be previously stored in the service server 100.

The virtual card number can match the mobile phone number and the card information of a card that will be used in a payment. Therefore, the virtual card number and the card information can be mapped and stored in the card company system 400.

In addition, the service server 100 can store the mobile phone number and the virtual card number by mapping. That is, the card number matching the mobile phone number may not be stored in the service server 100, but a piece of information with which the card number can be acquired, i.e. the virtual card number, can be stored in the service server 100. This piece of information can match the card information of the card that matches the mobile phone number. Therefore, the service server 100 can transmit an authentication request signal including the virtual card number to the card company system 400. Then, the card company system 400 can identify the card number of the card based on the virtual card number, and determine whether or not to authenticate a payment using the card based on the identified card number.

Therefore, the card information may not be circulated during communication between the service server 100 and the card company system 400. This consequently leads to an excellent security effect.

In addition, as described above, the service server 100 can transmit the authorization request information to the VAN system (not shown). When the authorization request information is received from the service server 100 or the VAN system, the card company system 400 can determine whether or not to authenticate a payment and an output authentication notification to the service server 100 depending on the result of determination.

According to another embodiment of the present invention, the user can register a plurality of cards with which a payment can be performed using his/her mobile phone number. For example, the user can register a first card of a card company A, a second card of a card company B and a third card of a card company C such that the cards match the mobile phone number. When the user performs a payment request through the terminal 210, the user can additionally input card selection information (S100). The card selection information can be a piece of information with which one of the card companies is selected or with which one of the cards is selected. When the technical idea of the present invention is embodied such that one of the card companies is selected, it is preferred that only one card of each card company match the mobile phone number. In this case, a virtual card number matching each card can be stored in the service server 100.

According to another implementation, the user can input his/her mobile phone number for the purpose of a payment request. Then, the service server 100 can inquire the type of a card that correspond to the inputted mobile phone number, and transmit the inquired information to the affiliate system 300. For example, assuming that the user has two cards from card company A, two cards from card company B and one card from card company C that correspond to his/her mobile phone number, when the user inputs his/her mobile phone number via a user interface (UI) provided by the affiliate system 300, the service server 100 can receive the mobile phone number from the affiliate system 300, and transmit card type information about the cards corresponding to the received mobile phone number. Here, the card type information can be information about text or images with which the user can identify the cards. Of course, since the service server 100 does not store card information (e.g. card number or expiration date), it is preferred that the card information be not included in the card type information. Then, the affiliate system 300 can display card type information about the five cards, i.e. card selection information, and the user can select one card from the card selection information. Of course, in some cases, the user must further input additional information (e.g. user identification information, personal identification number (PIN)) in addition to the mobile phone number in order to identify the card type information about the cards corresponding to his/her mobile phone number.

Then, the service server 100 can receive a payment request through the affiliate system 300 (S110), after which the service server 100 can perform a password confirmation process and then a payment authentication process through the mobile terminal 220 (S120, S130). When the service authentication has succeeded, the service server 100 can perform the payment authentication process by transmitting an authentication request signal to a card company system that matches the selected card (or card company).

The service server 100 can have the mobile phone number and matching user identification information (e.g. name, birth date or an email address) stored therein. In this case, when the user performs the payment request (S100), the user can further input his/her identification information. Then, the service server 100 can authenticate a service only if the user identification information and the mobile phone number that have been received through the affiliate system 300 are identical with the mobile phone number and user identification information that were stored previously. This may cause a trade-off in which an increase in information (e.g. user identification information) used for authentication leads to enhanced security and decreased user convenience. The user identification information can be, for example, the name, birth date or an email address of the user.

The term “card” that matches the mobile phone number can be understood as including any type of card that the card company system 400 can issue including a credit card or a check card. In some implementations, a separate card can be issued by a card company system for the service method for providing a card payment using a mobile phone number according to an embodiment of the present invention. Of course, it is possible to embody the technical idea of the present invention using a card that was previously issued.

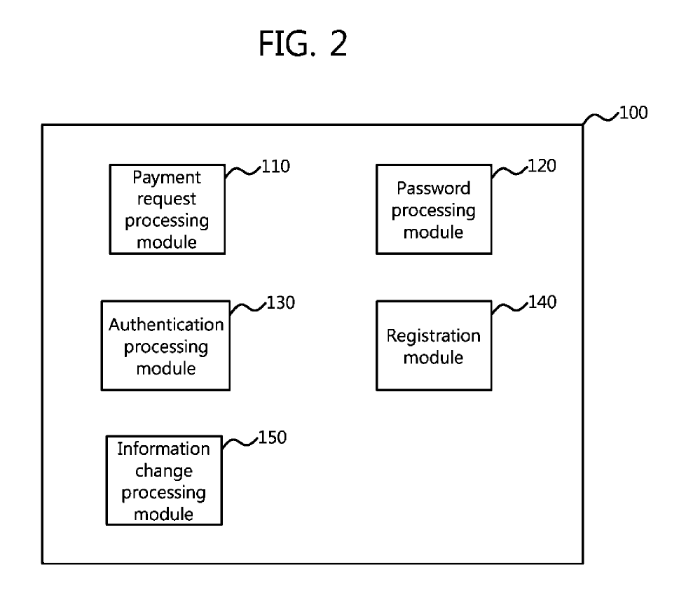

FIG. 2 is a view illustrating a schematic configuration of a system for providing a card payment using a mobile phone number according to an embodiment of the present invention.

Referring to FIG. 2, the service server 100 according to an embodiment of the present invention includes a payment request processing module 110, a password processing module 120 and an authentication processing module 130. The service server 100 can also include a registration module 140. In addition, the service server 100 can also include an information change processing module 150.

In the specification, the term “module” may indicate a functional and structural combination of hardware for performing the technical idea of the present invention and software for operating the hardware. For example, the module can indicate a logical unit that includes a set of codes and a hardware resource which execute the codes. It can be easily deduced by a person having ordinary skill in the art to which the present invention belongs that the module does not necessarily mean codes that are physically connected or one type of hardware. Therefore, the module indicates a combination of hardware and software that executes the functions disclosed in the specification but does not indicate a specific physical structure.

In addition, the service server 100 can indicate a logical structure including a hardware resource and/or a piece of software which are required to embody the technical idea of the present invention. However, the service server 100 does not necessarily indicate either one physical component or one device. That is, the service server 100 can indicate a logical combination of hardware and/or software which are provided in order to embody the technical idea of the present invention. The service server 100 can also be a set of logical components that are disposed at remote devices such that they perform respective functions in order to embody the technical idea of the present invention as required. In addition, the service server 100 can indicate a set of components that are separately embodied depending on respective functions or roles in order to embody the technical idea of the present invention.

For example, the payment request processing module 110, the password processing module 120, the authentication processing module 130, the registration module 140 and/or the information change processing module 150 can be positioned at different physical devices or the same physical device. In addition, in some embodiments, the combinations of software and/or hardware which respectively constitute the payment request processing module 110, the password processing module 120, the authentication processing module 130, the registration module 140 and/or the information change processing module 150 can be positioned at different physical devices such that components positioned at the different physical devices are organically combined to thereby embody these modules.

The payment request processing module 110 receives a payment request including the mobile phone number of the mobile terminal 220 of the user that is inputted by the user terminal 210 from the affiliate system 300 on the wired/wireless network (e.g. wired/wireless Internet). In some implementations, the payment request can further include user identification information (e.g. name or an email address) and/or card selection information. In any case, it is preferred that the payment request include the mobile phone number. In addition, in order to receive the card selection information as described above, the payment request processing module 110 can transmit card type information corresponding to the mobile phone number to the affiliate system 300, and when the user makes a selection in response to the transmitted card type information, receive the card selection information. For this, the payment request processing module 110 can inquire the card type information corresponding to the mobile phone number that is previously stored in the service server 100. Examples of the card type information may include card name, card company name, or the like.

Then, the password processing module 120 can connect a telephone call to the mobile terminal 220 using the mobile phone number included in the received payment request. Afterwards, the password processing module 120 can request an input of a preset service password, and receive the service password that is inputted in response to the request.

Then, the authentication processing module 130 can determine whether or not the received password matches the mobile phone number and is identical to a service password that was previously registered in the service server 100, i.e. whether or not to authenticate the service. In the case of the service authentication, the authentication processing module 130 can perform a payment authentication process using a card matching the mobile phone number. The card matching the mobile phone number can be one card as described above, or can be a plurality of cards. Therefore, when the plurality of cards corresponds to the mobile phone number, the payment authentication process performed using the card matching the mobile phone number can be a series of procedures in which an authentication request signal is transmitted to the card company system 400 of the card matching the card selection information and an authentication is acquired.

When the plurality of cards corresponds to the mobile phone number, it is preferred that the card selection information be included in payment request information that the payment request processing module 110 receives. The card selection information can be information with which a card company is selected, or in some implementations, can be information with which a specific card is selected. When the user is required to select a specific card, it is preferred that the card selection information be information with which cards can be identified and in which the card information is not included. Therefore, it is preferred that the card number be not directly circulated on the network.

In addition, it is preferred that a service password matching the mobile phone number be previously registered in the service server 100. In some implementations, user identification information, card type information and/or a virtual card number matching the mobile phone number may have also been registered in the service server 100. For this, the service server 100 can further include the registration module 140.

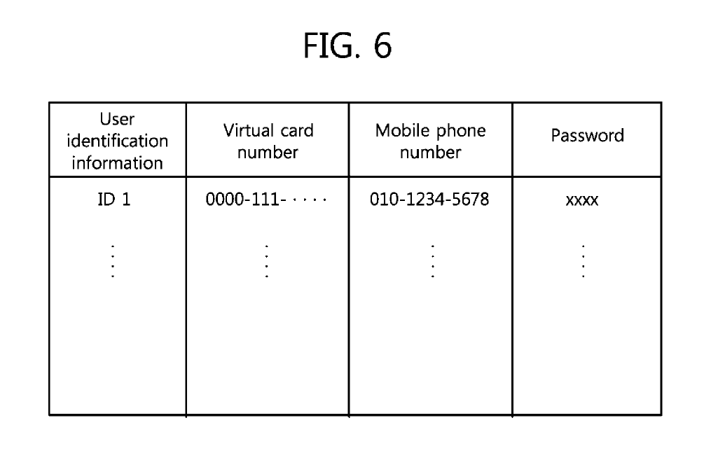

Examples of information that can be registered by the registration module 140 are shown in FIG. 6.

FIG. 6 is a view showing examples of information that can be registered in the service server in order to embody the method for providing a card payment using a mobile phone number according to an embodiment of the present invention. Referring to FIG. 6, the registration module 140 stores at least a service password matching the mobile phone number, and can also store card type information (e.g. card name or card company name) about cards corresponding to the mobile phone number or user identification information (e.g. name or birth date). Although FIG. 6 shows a case where one piece of card identification information matches one mobile phone number, a plurality of pieces of card information can match one mobile phone number as described above.

In addition, the service server 100 can further store a virtual card number matching the mobile phone number.

The password and/or the user identification information can be used for a service authentication that is determined by the authentication processing module 130. In addition, the virtual card number can be used in the payment authentication process.

In addition, when the user identification information is also stored in the registration module 140, the authentication processing module 130 can authenticate a service after user identification information is further inputted from the user terminal 210 and if the inputted user identification information is identical with the user identification information stored in the registration module 140 (that is, in addition to when the password is identical).

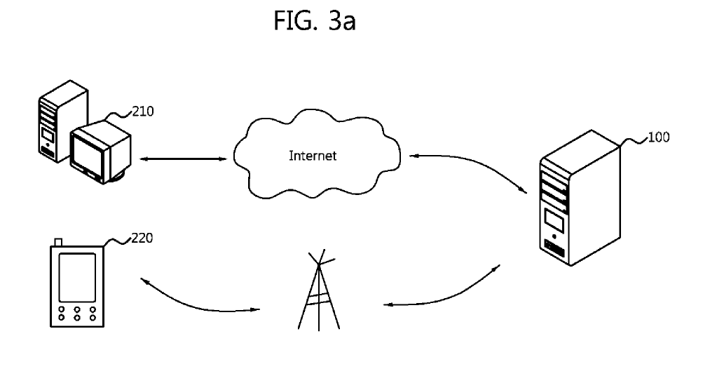

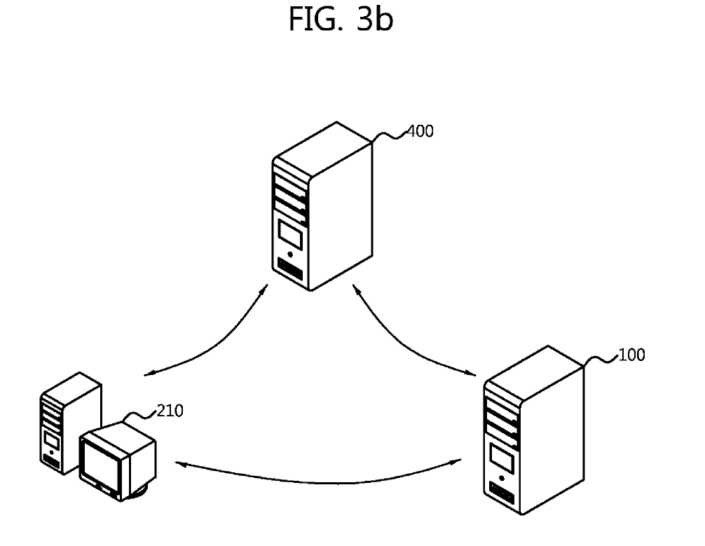

In addition, the registration module 140 can process membership registration from the user terminal 210 for the service according to an embodiment of the present invention. Such an example is shown in FIG. 3a.

FIG. 3a is a view illustrating a card registration process or an information changing process in the method for providing a card payment using a mobile phone number according to an embodiment of the present invention.

Referring to FIG. 3a, in order to use the service of the method for providing a card payment using a mobile phone number according to an embodiment of the present invention, the user can access the service server 100 on the wired/wireless data network using the user terminal 210 and then sends a service registration request. When the service registration request is received, the service server 100 can request at least one piece of user identification information, a mobile phone number and name from the user terminal 210.

In addition, the process of setting the service password to be used in the service can be performed, in which the service password can be received through a telephone call. That is, the service server 100 can establish the telephone call using the inputted mobile phone number. For example, the service server 100 can establish the telephone call and request the service password via an ARS. Then, the user can set his/her service password through the connected telephone call, and the service password can be stored in the service server 100. Since the registration process for the service password is also performed through the telephone call in this fashion, it is possible to prevent the user from registering another mobile phone number instead of his/her mobile phone number. Since the service password is registered through different channels, there is an effect in that more stringent security can be provided than in the case where service password registration is performed through one channel such as the Internet.

In addition, in some cases, the mobile phone number that is inputted when the user requests membership registration can be the telephone number that was previously registered. For example, this can be the case where another user previously registered using a specific mobile phone number before the current user came to use the specific mobile phone number as his/her telephone number.

The method for providing a card payment using a mobile phone number according to an embodiment of the present invention may not separately maintain and/or manage the resident registration number of the user. In this case, only the mobile phone number can be user-specific unique information. In some cases, unique information such as an email address can be further maintained and/or managed. Thus, when the mobile phone number is double-registered, there can be a severe danger to the safety of the service. Therefore, when a mobile phone number that is used in a service registration request received from the user terminal 210 is a mobile phone number that was previously registered by another user, the registration module 140 can inactivate the account of another user. That is, when a service registration request by a user is completed, it is proved that the mobile terminal 220 corresponding to the mobile phone number is possessed by the user. Since it can be assumed that another user does not use that mobile phone number anymore, it is possible to inactivate the account of another user. When another user attempts to use the service according to an embodiment of the present invention, the process of changing the telephone number of another user can be automatically started. This effect can prevent a case where another user does not update a new mobile phone number in the service server 100.

In addition, in the service according to an embodiment of the present invention as described above, the mobile phone number is information with which the user can be identified. When the mobile phone number is changed, there may be a problem in that the user identification information, i.e. the user-specific unique information, is changed. That is, the mobile phone number can function like an ID in common web services of the related art. In related-art web services, there are problems in that a change in the ID is not allowed or that a complicated process of withdrawing from the service and re-registering the service is required. In addition, in related-art web services, there are currently few cases where the ID needs to be changed since it is rare when a user needs to change the ID.

However, in the case where the mobile phone number is used as ID according to the technical idea of the present invention, the actual mobile phone number of the user can be frequently changed. Therefore, it can be effective when the mobile phone number, the unique information of the user, can be efficiently changed such that the user can change the mobile phone number without withdrawing from and re-registering the service. The process of changing the mobile phone number can be performed by the information change processing module 150.

The information change processing module 150 can receive a mobile phone number change request from the user terminal 210. Then, he information change processing module 150 can request a new mobile phone number from the user terminal 210.

In some implementations, when the mobile phone number change request is received, the information change processing module 150 can further perform an identification process by requesting the user-specific unique information (e.g. a mobile phone number before being changed or an email address) stored in the service server 100 from the user terminal 210. For instance, in the case where the mobile phone number and the email address are stored as the user-specific unique information in the service server 100, the information change processing module 150 can identify the user through the email when the mobile phone number change request is received. When the user is identified, the information change processing module 150 can request the new mobile phone number from the user terminal 210. Of course, when the mobile phone number change request is received, the user identification can also be performed using the old mobile phone number.

When the new mobile phone number is inputted from the user terminal 210, the information change processing module 150 can establish a telephone call using the new mobile phone number. Then, the information change processing module 150 can request a service password through the connected telephone call. If the service password received through the connected telephone call is identical to a previously-stored service password, the information change processing module 150 can authorize a telephone number change into the new mobile phone number. That is, the new mobile phone number can be stored in the account of the user through mapping. When the change of the mobile phone number is completed, the information change processing module 150 can send a notice of change in the mobile phone number through a message and/or an email.

According to another embodiment, the information change processing module 150 can transmit a callback message to the new telephone number. The user can connect a telephone call to the ARS using the callback message. Then, the process of verifying the previously-set service password can be performed through the connected telephone call. Afterwards, the notice of change in the mobile phone number can be informed through a message and/or an email.

Consequently, the user who uses the service according to the present invention can request a payment by inputting the mobile phone number without inputting the user-specific unique information such as ID. When the mobile phone number used for requesting a payment is changed, a change request is performed on the wired/wireless data network and the verification of the change request is performed through a telephone call, thereby leading to an excellent security effect.

According to a further embodiment, the user can call to the ARS in person to input the old mobile phone number and the service password. After being verified through this, the user can change the telephone number by inputting a new telephone number. In this case, of course, the information change processing module 150 can transmit a notice of change through a message or an email after the telephone number is changed.

As such, according to the technical idea of the present invention, the service password is received through the new mobile phone number. Accordingly, it is possible to confirm that the user uses the new mobile phone number and perform the simple process of changing the mobile phone number.

In addition, the service server 100 can maintain and/or manage an email, which can be a piece of unique information with which the user can be identified. Therefore, the email can also be changed in the same fashion by the information change processing module 150. That is, when an email information change request is received from the user terminal 210, the information change processing module 150 can change the email information through a verification process on a service password by establishing a telephone call in response to the request. In this case, when the user is verified through the verification process using the existing email or mobile phone number, it is also possible to perform a service password verification process through a telephone call in order to change the email information.

In addition, the user must perform the process of registering a card to be used for payments using the service according to an embodiment of the present invention. This will be described with reference to FIG. 3B.

FIG. 3b is a view illustrating the card registration process in the method for providing a card payment using a mobile phone number according to an embodiment of the present invention.

Referring to FIG. 3b, the user can send a card registration request through the user terminal 210 to the service server 100. Then, the service server 100 can request a piece of card information about a card to be registered (e.g. card number, effective period, card password or CVC) from the user terminal 210. In some implementations, the service server 100 can load a webpage such that the user terminal 210 can access the card company system 400 and input the card information. Accordingly, the user terminal 210 can send the card registration request to both of the service server 100 and the card company system 400. In addition, the service server 100 or the card company system 400 can perform the process of verifying the user (e.g. public verification or mobile phone verification).

When the user verification process is passed, the service server 100 can generate a virtual card number matching the mobile phone number of the user and transmit the virtual card number to the card company system 400. Then, the card company system 400 can store the mobile phone number and the virtual card number through mapping.

Of course, when the user intends to register a plurality of cards on the mobile phone number, the service server 100 can store card type information (card name and/or card company name) and the virtual card number through mapping.

Accordingly, when the service server 100 has received a payment request from the user terminal 210 and the password verification has succeeded, the authentication processing module 130 can sends a payment authentication request using the virtual card number to the card company system 400 in response to the payment request. Of course, the payment authentication request can be sent to the card company system 400 through a VAN system (not shown).

Then, the card company system 400 can extract card information matching the virtual card number and determine whether or not to make a payment authentication based on the extracted card information. Therefore, no card information can be circulated between the service server 100 and the card company system 400.

In addition, the method for providing a card payment using a mobile phone number according to an embodiment of the present invention as described above can perform the password verification through a telephone call. In this case, a telephone call may be not established depending on the circumstance of the user. In this case, it may be improper to repeatedly send a telephone call. Therefore, a technical idea with which the password authentication can be performed when the user cannot receive a call is also required.

For this, the system for providing a card payment using a mobile phone number according to an embodiment of the present invention, i.e. the password processing module 120 of the service server 100, can transmit a callback message to the mobile phone number. Then, in the circumstance where the user is to perform a password verification, the user can select the callback message transmitted to the user terminal 210. The callback message can include the telephone number of an ARS included in or connected to the service server 100. Therefore, when the user selects the callback message, a telephone call can be connected to the ARS. Then, the ARS can identify the telephone number of the incoming call, i.e. the mobile phone number, and the service password can be received through the ARS. When the received service password is identical to a previously-stored service password, the password processing module 120 can inform the authentication processing module 130 that the password verification has succeeded.

When the password verification is not successfully performed for a preset period, the password processing module 120 can transmit payment request identification information to the user terminal 210 and/or the mobile terminal 220. Specifically, in some cases, the user may not receive a call or a callback is not received from the user for a preset period. In such a case, a preset piece of identification information (e.g. a payment request serial number) with which the payment request can be identified can be sent to the user terminal 210. Transmitting the payment request identification information to the user terminal 210 can be defined as including transmitting the payment request identification information through the affiliate system 300. In some implementations, the payment request identification information can be directly transmitted to the mobile terminal 220. In this case, the payment request identification information can be included in the callback message or be transmitted separate from the callback message. Afterwards, in the circumstance where the user can perform the password verification, the user can call to the ARS included in (or connected to) the service server 100 using the callback message. Then, the user can perform a password verification by inputting a service password. Since the payment request identification information is further inputted, it is possible to identify on what payment request the user is performing the password verification. This consequently leads to an effect in that, when the user performed a plurality of payment requests, he/she can perform the password verification after a preset time.

In addition, the password processing module 120 can transmit the callback message to the mobile phone number if a telephone call is not connected after it was attempted to connect the telephone call to the mobile phone number. In contrast, according to another embodiment, it is possible to perform the password verification using the callback message from the beginning. In addition, although the payment request identification information can be sent to the user terminal 210 and/or the mobile terminal 220 if the password verification is not performed for a preset period, it is also possible to output the payment request identification information unconditionally and then perform the password verification using the payment request identification information and the service password.

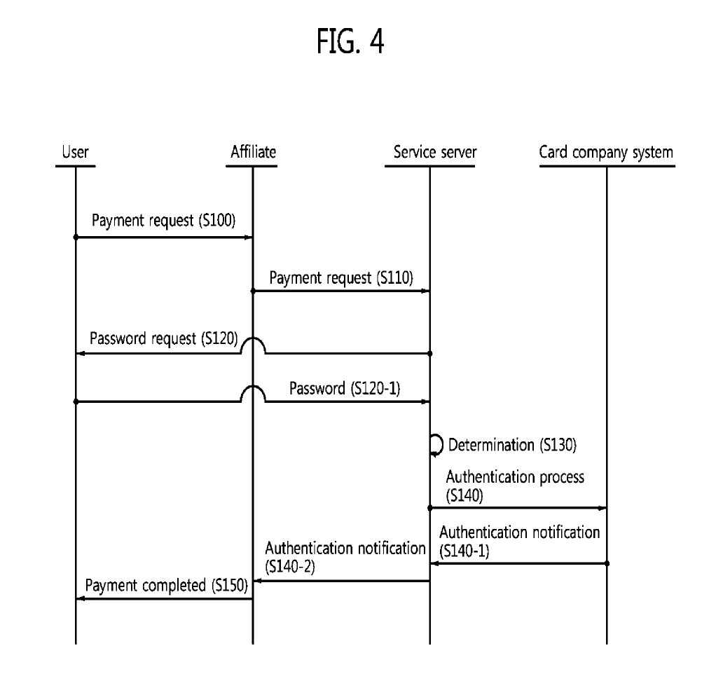

FIG. 4 is a view schematically illustrating a data flow in the method for providing a card payment using a mobile phone number according to an embodiment of the present invention.

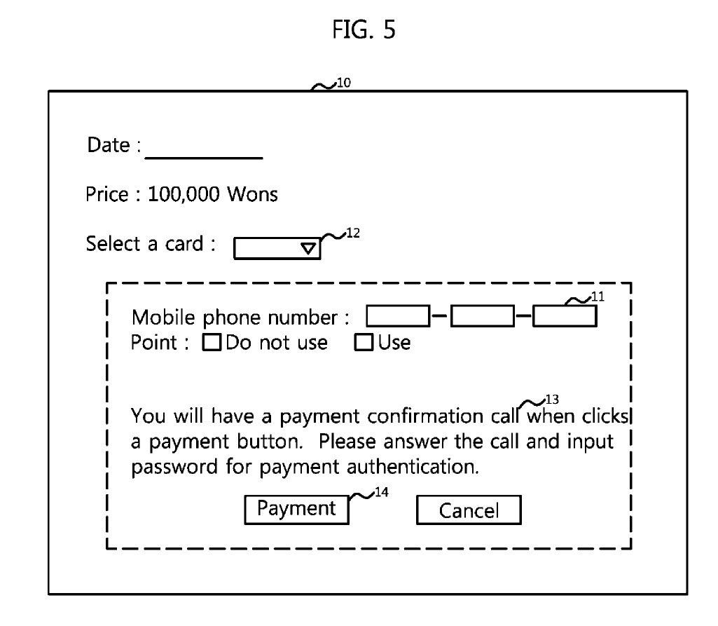

Referring to FIG. 4, in order to use the service of the method for providing a card payment using a mobile phone number according to an embodiment of the present invention, the user can access the affiliate system 300 using the user terminal 210 for web surfing, shopping, or the like. Then, the user can transmit a payment request to the affiliate system 300 when he/she intends to make a payment (S100). It is preferred that this payment request include at least a mobile phone number (e.g. telephone number or PN). In some implementations, the payment request information can further include user identification information and/or card selection information. The user terminal can display a user interface (UI), as shown in FIG. 5, with which the payment request information can be inputted.

FIG. 5 is a view showing an example of a payment UI provided to a user in order to embody the method for providing a card payment using a mobile phone number according to an embodiment of the present invention. Referring to FIG. 5, when the user sends a payment request to the affiliate system 300, the user terminal 210 can be provided with the UI 10 shown in FIG. 5. The user can input, for example, the mobile phone number using a UI 11 included in the UI 10. In some implementations, it is possible to input card selection information using a card selection UI 12. When the user selects (e.g. clicks) the card selection UI 12, a list of card companies can be displayed on the user terminal 210, and the user can select one of card companies that are displayed in the list. Then, a payment can be performed using the card of the selected card company that matches the mobile phone number that is inputted. In addition, as shown in FIG. 5, the UI 10 can also provide a statement that describes the service according to an embodiment of the present invention through a UI 13. When the user selects a payment UI 14, the payment request information can be sent to the service server 100 (S110) through the affiliate system 300 (S100).

Referring to FIG. 14 again, the service server 100 which has received the payment request can request a password from the mobile terminal 220 using the mobile phone number (e.g. portable telephone number) included in the received payment request (S120). This password request can be performed through establishment of a telephone call as described above. That is, this password request can be performed through an ARS call. In addition, according to another embodiment, a callback message can be transmitted to the user such that the user calls to an ARS. Then, the password processing module 120 of the service server 100 can receive the password through a second communication channel in response to the request (S120-1). In addition, the password processing module can determine whether or not to authenticate the service by comparing the mobile phone number (e.g. portable telephone number) to the corresponding service password (S130). When a piece of user identification information (e.g. name or birth date) is inputted into the payment request information, it is possible to determine whether or not to authenticate the service by determining whether or not the user identification information included in the payment request information is identical to the previously-registered user identification information.

When it is determined to authenticate the service, the service server 100 can perform the payment authentication process.

As shown in FIG. 4, the payment authentication process can be performed as the authentication processing module 130 of the service server 100 transmits the authentication request signal to the card company system 400 by adding the virtual card number matching the previously-stored mobile phone number to the authentication request signal (S140). When the card selection information is included in the payment request, the authentication request signal can be transmitted to the card company system 400 that corresponds to the card selection information. Of course, the authentication request signal can further include information about the amount of money to be paid. Then, the card company system 400 can identify a piece of card information matching the received virtual card number and determine whether or not to authenticate the requested payment using a card matching the card information. According to the result of determination, the card company system 400 can send an authentication notification to the authentication processing module 130 (S140-1), the authentication processing module 130 can forward the authentication notification to the affiliate system 300 (S140-2), and the affiliate system 300 can notify the user terminal 210 that the payment is completed (S150).

The service server 100 according to an embodiment of the present invention can perform the function of a VAN system in a payment system of the related art, the function of a payment gateway (PG), or the function of the above-described independent payment server, depending on the embodiments.

The method for providing a card payment using a mobile phone number according to an embodiment of the present invention can be embodied as computer readable codes that are stored in a computer readable recording medium. The computer readable recording medium includes all sorts of record devices in which data that are readable by a computer system are stored. Examples of the computer readable recording medium include read only memory (ROM), random access memory (RAM), compact disc read only memory (CD-ROM), a magnetic tape, a hard disc, a floppy disc, an optical data storage device and the like. Further, the recording medium may be implemented in the form of a carrier wave (e.g. Internet transmission). In addition, the computer readable recording medium may be distributed to computer systems on the network, in which the computer readable codes are stored and executed in a decentralized fashion. In addition, functional programs, codes and code segments for embodying the present invention can be easily construed by programmers having ordinary skill in the art to which the present invention pertains.

While the present invention has been described with reference to the certain exemplary embodiments which are shown in the drawings, it will be understood by a person having ordinary skill in the art that various modifications and equivalent other embodiments may be made therefrom. Therefore, the true scope of the present invention shall be defined by the technical principle of the appended claims.

### INDUSTRIAL APPLICABILITY

The present invention is applicable to a payment system.

1. A method for providing a card payment using a mobile phone number of a mobile terminal, the method comprising:
receiving, at a service server, a payment request from an affiliate system through a wired/wireless data network, the payment request being inputted through a user terminal and including a mobile phone number of a mobile terminal of a user;
connecting, at the service server, a telephone call to the mobile terminal using the mobile phone number included in the received payment request;
when the telephone call is connected, requesting, at the service server, an input of a service password through the connected telephone call; and
when a service password received through the telephone call from the mobile terminal is identical to a service password stored in the service server, performing, at the service server, a payment authentication process using a virtual card number generated by the service server, the virtual card number being mapped to a card matching the mobile phone number.

2. The method according to claim 1, wherein the payment request includes the mobile phone number and a confirmation information, and
wherein the process of connecting, at the service server, the telephone call to the mobile terminal using the mobile phone number included in the received payment request comprises:
determining whether or not the confirmation information corresponds to the mobile phone number; and
when it is determined that the confirmation information corresponds to the mobile phone number, connecting the telephone call to the mobile terminal.

3. The method according to claim 1, further comprising:
when a mobile phone number change request is received from the user terminal, connecting, at the service server, a telephone call to a new mobile phone number; and
receiving a password through the connected telephone call with the new mobile phone number, and when the received password is identical to the stored service password, authenticating a change to the new mobile phone number of the user.

4. The method according to claim 1, further comprising:
when a mobile phone number change request is received from the user terminal, transmitting, at the service server, a callback message to a new mobile phone number; and
when a telephone call is connected based on the transmitted callback message, receiving a password through the connected telephone call, and when the received password is identical to the stored service password, authenticating a change to the new mobile phone number of the user.

5. The method according to claim 1, further comprising:
receiving, at the service user, a service registration request including the mobile phone number from a user terminal;
requesting, at the service server, a service password by connecting a telephone call to the mobile terminal corresponding to the mobile phone number in response to the received service registration request; and
receiving, at the service server, the service password through the connected telephone call and storing the received service password.

6. The method according to claim 5, further comprising:
when the mobile phone number included in the received service registration request is already registered by another user, inactivating, at the service server, an account of the another user; and
when a terminal of the another user accesses the service server, automatically performing a telephone number change process by requesting a new telephone number.

7. The method according to claim 1, further comprising:
when the user terminal sends a registration request to at least one of the service server and a card company system corresponding to the card, generating, at the service server, the virtual card number matching card information of the card; and
sending, at the service server, the generated virtual card number to the card company system,
wherein the process of performing, at the service server, the payment authentication process using the virtual card number generated by the service server comprises:
transmitting, at the service server, the virtual card number matching the mobile phone number to the card company system or a value added network system; and
receiving, at the service server, a payment authentication result from the card company system or the value added network system in response to _transmitting the virtual card number, and
wherein the card company system identifies the card matching the virtual card number received from the service server or the value added network system, and determines whether or not to authenticate a payment using the identified card.

8. The method according to claim 1, further comprising:
when the telephone call is not connected, transmitting, at the service server, a callback message to the mobile phone number;
connecting a telephone call from the mobile terminal using the transmitted callback message;
receiving, at the service server, a password through the connected telephone call; and
when the received password is identical to the service password stored in the service server, performing the payment authentication process using the card matching the mobile phone number.

9. The method according to claim 8, further comprising:
when the password has not been received from the mobile terminal for a predetermined period, transmitting, at the service server, a payment request identification information corresponding to the payment request to at least one of the user terminal and the mobile terminal; and
further receiving, at the service server, the payment request identification information through the connected telephone call from the mobile terminal using the transmitted callback message,
wherein, when the received password is identical to the service password, the process of performing the payment authentication process using the virtual card number generated by the service server comprises:
performing, at the service server, the payment authentication process for the payment request corresponding to the payment request identification information.

10. A method for providing a card payment using a mobile phone number of a mobile terminal, the method comprising:
receiving, at a service server, a payment request from an affiliate system through a wired/wireless data network, the payment request being inputted through a user terminal and including a mobile phone number of a mobile terminal of a user;
connecting, at the service server, a telephone call to the mobile terminal using the mobile phone number included in the received payment request;
when the telephone call is connected, requesting, at the service server, an input of a service password through the connected telephone call;
when the service password received through the telephone call from the mobile terminal is identical to a service password stored in the service server, transmitting, at the service server, a virtual card number to a card company system or a value added network system, the virtual card number matching the mobile phone number and being previously stored in the service server;
when the card company system identifies the card matching the virtual card number and determines whether or not to authenticate a payment using the identified card, receiving, at the service server, a determined payment authentication result from the card company system or the value added network system; and
transmitting, at the service server, the received payment authentication result to at least one of the affiliate system and the mobile terminal.

11. A method for providing a card payment using a mobile phone number of a mobile terminal, the method comprising:
receiving, at a service server, a payment request from an affiliate system through a wired/wireless data network, the payment request being inputted through a user terminal and including a mobile phone number of a mobile terminal of a user;
connecting, at the service server, a telephone call to the mobile terminal using the mobile phone number included in the received payment request;
when the telephone call is not connected, transmitting, at the service server, a callback message to the mobile phone number;
connecting a telephone call from the mobile terminal using the transmitted callback message;
receiving, at the service server, a password through the connected telephone call; and
when the received password is identical to the service password, performing the payment authentication process using the card matching the mobile phone number.

12. A method for providing a card payment using a mobile phone number of a mobile terminal, the method comprising:
receiving, at a service server, a payment request from an affiliate system through a wired/wireless data network, the payment request being inputted through a user terminal and including a mobile phone number of a mobile terminal of a user;
transmitting, at the service server, a callback message to the mobile phone number and a payment request identification information corresponding to the payment request to the affiliate system;
connecting a telephone call from the mobile terminal using the transmitted callback message;
receiving, at the service server, a service password and the payment request identification information through the connected telephone call; and
when the received service password is identical to a previously stored service password, performing, at the service server, a payment authentication process using a virtual card number generated by the service server, the virtual card number being mapped to a card matching the mobile phone number.

13. A computer readable recording medium in which a program for executing the method recited in claim 1.

14. A system for providing a card payment using a mobile phone number of a mobile terminal, comprising:
a payment request processing module which receives a payment request from an affiliate system through a wired/wireless data network, the payment request being inputted through a user terminal and including a mobile phone number of a mobile terminal of a user;
a password processing module which connects a telephone call to the mobile terminal using the mobile phone number included in the received payment request, and when the telephone call is connected, requests an input of a service password through the connected telephone call; and
an authentication processing module, wherein, when a service password received through the telephone call from the mobile terminal is identical to a service password stored in a service server, performs a payment authentication process using a virtual card number generated by the service server, the virtual card number being mapped to a card matching the mobile phone number.

15. The system according to claim 14, further comprising an information change processing module, wherein the information change processing module connects a telephone call to a new mobile phone number when a mobile phone number change request is received from the user terminal, receives a password through the connected telephone call, and when the received password is identical to the stored service password, authenticates a change to the new mobile phone number of the user.

16. A system for providing a card payment using a mobile phone number of a mobile terminal, comprising:
a payment request processing module which receives a payment request from an affiliate system through a wired/wireless data network, the payment request being inputted through a user terminal and including a mobile phone number of a mobile terminal of a user;
a password processing module which connects a telephone call to the mobile terminal using the mobile phone number included in the received payment request, and when the telephone call is connected, requests an input of a service password through the connected telephone call; and
an authentication processing module, wherein, when a service password received through the telephone call from the mobile terminal is identical to a service password stored in a service server, transmits a virtual card number to a card company system or a value added network system, the virtual card number matching the mobile phone number and being previously stored,
wherein, when the card company system identifies the card matching the virtual card number and determines whether or not to authenticate a payment using the identified card, the authentication processing module receives a determined payment authentication result from the card company system or the value added network system and transmits the received the payment authentication result to at least one of the affiliate system and the mobile terminal.

17. A system for providing a card payment using a mobile phone number of a mobile terminal, comprising:
a payment request processing module which receives a payment request from an affiliate system through a wired/wireless data network, the payment request being inputted through a user terminal and including a mobile phone number of a mobile terminal of a user;
a password processing module which connects a telephone call to the mobile terminal using the mobile phone number included in the received payment request, transmits a callback message to the mobile phone number when the telephone call is not connected, and when a telephone call is connected from the mobile terminal using the transmitted callback message, receives a password through the connected telephone call; and
an authentication processing module which performs the payment authentication process using the card matching the mobile phone number when the received password is identical to the service password stored in a service server.

18. A system for providing a card payment using a mobile phone number of a mobile terminal, comprising:
a payment request processing module which receives a payment request from an affiliate system through a wired/wireless data network, the payment request being inputted through a user terminal and including a mobile phone number of a mobile terminal of a user;
a password processing module which transmits a callback message to the mobile phone number and a payment request identification information corresponding to the payment request to the affiliate system, and when a telephone call is connected from the mobile terminal to a service server using the transmitted callback message, receives a service password and the payment request identification information through the connected telephone call; and
an authentication processing module, wherein, when the received service password is identical to a previously stored service password, the authentication processing module performs a payment authentication process using a virtual card number generated by the service server, the virtual card number being mapped to a card matching the mobile phone number.

19. A computer readable recording medium in which a program for executing the method recited in claim 10.

20. A computer readable recording medium in which a program for executing the method recited in claim 11.
